(19) United States
(12) Patent Application Publication
(10) Pub. No.: US 2013/0258232 A1
(43) Pub. Date: Oct. 3, 2013

(54) Middle Frame and Liquid Crystal Display Module

(71) Applicant: Gege Zhou, Shenzhen (CN)

(72) Inventor: Gege Zhou, Shenzhen (CN)

(73) Assignee: Shenzhen China Star Optoelectronics Technology Co. LTD., Shenzhen (CN)

(21) Appl. No.: 13/512,682

(22) PCT Filed: Apr. 13, 2012
(86) PCT No.: PCT/CN12/73965

§ 371 Date: May 30, 2012

(30) Foreign Application Priority Data
Mar. 30, 2012 (CN) 201210091034.7

(51) Int. Cl. G02F 1/13357; A47B 96/00

(52) U.S. Cl. 349/58; 211/183

(57) ABSTRACT

The present invention provides a middle frame and a liquid crystal display module. The middle frame comprises a plastic portion and a rubber portion. The plastic portion and the rubber portion are enclosed to form the middle frame. According to that, the present invention can reduce the manufacture cost of the middle frame and increase the elasticity of the middle frame.

### BACKGROUND OF THE INVENTION

1. Field of the Invention

The present invention relates to display technology, and more particularly relates to a middle frame and a liquid crystal display (LCD) module.

2. Description of Related Art

The conventional technology of LCD module generally comprises: a front frame, a LCD panel, a middle frame, several optical films, a light guide plate, a light source, and a back frame. The front frame, the middle frame, and the back frame have different functions respectively. The back frame carries all members of the LCD module and ensures the flatness of the LCD module. The front frame mainly fixes the LCD panel and prevents it from escaping. The middle frame mainly carries the LCD display panel, and also blocks some light leakage. Conventionally, the middle frame is basically manufactured by plastic injection molding; however, elasticity of plastic is relatively poor comparing to rubber. Besides, injection mold production cycle is long, and price is high, leading to high development costs.

### SUMMARY OF THE INVENTION

The main technical problem solving by the present invention is to provide a middle frame and a LCD module; therefore reducing manufacturing costs of the middle frame and improving the elasticity of the middle frame.

A technical program of the present invention to solve the technical problems is providing a liquid crystal display module comprising:

a light guide plate having a light incidence surface;
a light source disposed at the light incidence surface of the light guide plate;
a middle frame having a plastic portion and a rubber portion, wherein the plastic portion and the rubber portion are enclosed to form the middle frame, and the portion of the middle frame corresponding to the light source is provided for the plastic portion, and the portion of the middle frame 10 not corresponding to the light source is provided for the rubber portion, and the plastic portion and the rubber portion are rectangles; and
a back frame having a sidewall, wherein the back frame is used for carrying the light guide plate, and the light source is disposed at the sidewall of the back frame.

Wherein, the plastic portion has one plastic section and the rubber portion has three rubber sections, and the one plastic section and the three rubber sections are enclosed to form the middle frame.

Wherein, the plastic portion has two plastic sections and the rubber portion has two rubber sections, and the two plastic sections and the two rubber sections are enclosed alternately to form the middle frame.

Wherein, the liquid crystal display module further comprising:

a liquid crystal display panel carried on the middle frame; and
a front frame engaged with the back frame for fixing the liquid crystal display panel.

Another technical program of the present invention to solve the technical problems is providing a liquid crystal display module comprising:

a light guide plate having a light incidence surface;
a light source disposed at the light incidence surface of the light guide plate; and
a middle frame having a plastic portion and a rubber portion, wherein the plastic portion and the rubber portion are enclosed to form the middle frame, and the portion of the middle frame corresponding to the light source is provided for the plastic portion, and the portion of the middle frame 10 not corresponding to the light source is provided for the rubber portion.

Wherein, the plastic portion has one plastic section and the rubber portion has three rubber sections, and the one plastic section and the three rubber sections are enclosed to form the middle frame.

Wherein, the plastic portion has two plastic sections and the rubber portion has two rubber sections, and the two plastic sections and the two rubber sections are enclosed alternately to form the middle frame.

Wherein, the plastic portion and the rubber portion are rectangles.

Wherein, the liquid crystal display module further comprises a back frame for carrying the light guide plate, and the light source fix to the sidewall of the back frame.

Wherein, the liquid crystal display module further comprising:

a liquid crystal display panel carried on the middle frame; and
a front frame engaged with the back frame for fixing the liquid crystal display panel.

Another technical program of the present invention to solve the technical problems is providing a middle frame comprising:

a plastic portion; and
a rubber portion;
wherein the plastic portion and the rubber portion are enclosed to form the middle frame.

Wherein, the plastic portion has one plastic section and the rubber portion has three rubber sections, and the one plastic section and the three rubber sections are enclosed to form the middle frame.

Wherein, the plastic portion has two plastic sections and the rubber portion has two rubber sections, and the two plastic sections and the two rubber sections are enclosed alternately to form the middle frame.

Wherein, the plastic portion and the rubber portion are rectangles.

### BRIEF DESCRIPTION OF THE DRAWINGS

FIG. 1 is a perspective exploded view of the LCD module of the first embodiment of the present invention;

FIG. 2 is a cross-section view of the LCD module of the first embodiment of the present invention;

FIG. 3 is a cross-section view of the LCD module of the second embodiment of the present invention;

FIG. 4 is a front view of the middle frame of the first embodiment of the present invention;

FIG. 5 is a front view of the middle frame of the second embodiment of the present invention;

FIG. 6 is a front view of the middle frame of the third embodiment of the present invention;

FIG. 7 is a front view of the middle frame of the fourth embodiment of the present invention;

FIG. 8 is a front view of the middle frame of the fifth embodiment of the present invention;

FIG. 9 is a front view of the middle frame of the sixth embodiment of the present invention;

### DETAILED DESCRIPTION OF THE PREFERRED EMBODIMENT

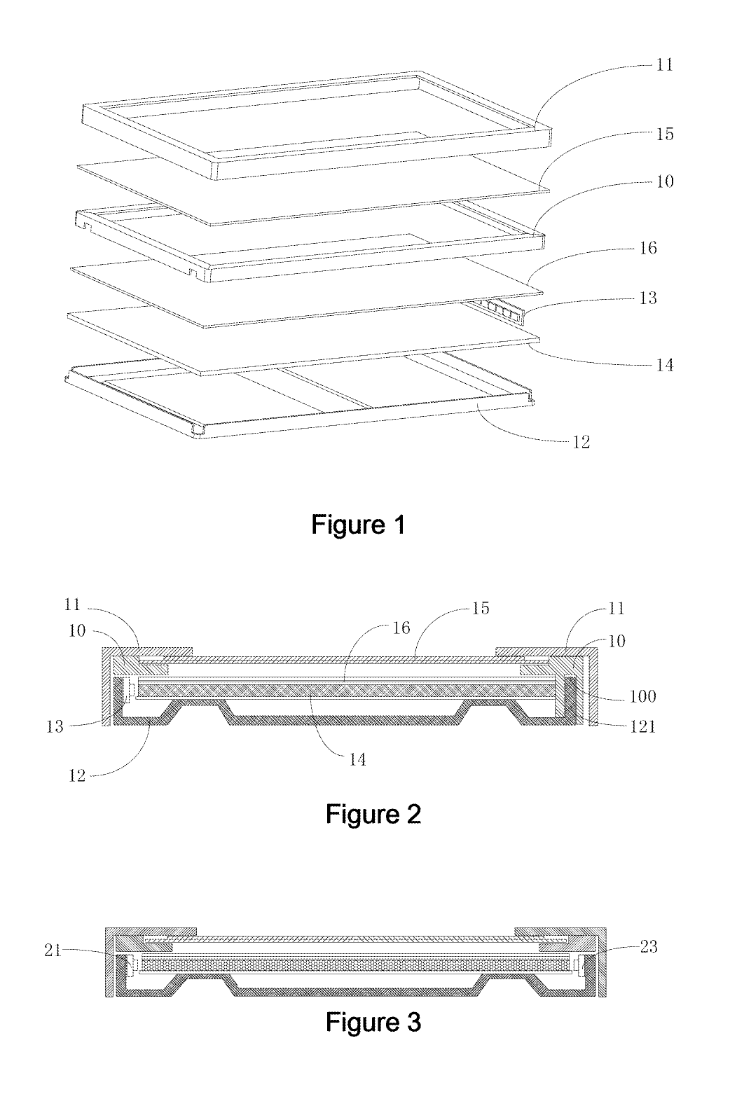

As shown in FIG. 1, FIG. 1 is a perspective exploded view of the LCD module of the first embodiment of the present invention. The liquid crystal display (LCD) module of the present invention comprising: a front frame 11, a LCD panel 15, a middle frame 10, a optical film 16, a light source 13, a light guide plate 14 and a back frame 12.

Please also refer to FIG. 2, as shown in FIG. 2, the light guide plate 14 is disposed on the bottom surface of the back frame 12, and the light source 13 is disposed at light incidence surface of the light guide plate 14 for outputting light to the light guide plate 14. The LCD panel 15 is carried on the middle frame 10, and the front frame 11 and back frame 12 are engaged together for fixing the LCD panel 15. The middle frame 10 provides an engaging portion 100 and the back frame 12 provides an insertion portion 121 for fixing with the engaging portion 100. As a result, the back frame 12 is relatively fixed to the middle frame 10, and the light source 13 is fixed to the sidewall of the back frame 12. In addition, the optical film 16 is disposed on the light guide plate 14, wherein the optical film 16 may be a polarizer film, a filter film, or a variety of optical films. The present invention is not specific limit. The light guide plate 14 and the optical film 16 can be fixed to the back frame 12 by rivet (not shown).

In this embodiment, the light source 13 is a LED light bar, using the light guide plate 14 to achieve unidirectional light guiding. Please refer to FIG. 3, FIG. 3 is a cross-section view of the LCD module of the second embodiment of the present invention. In the second embodiment, the light source includes two LED light bars 21, 23, respectively disposing at the two light incident sides of the light guide plate 14, and using the light guide plate 14 to achieve bilateral light guiding. As a result, the light intensity is increased.

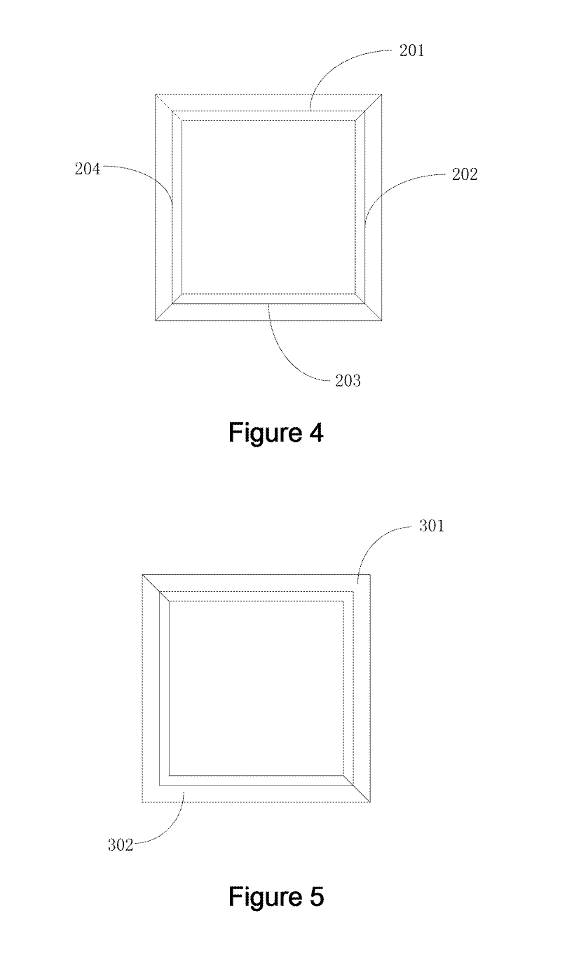

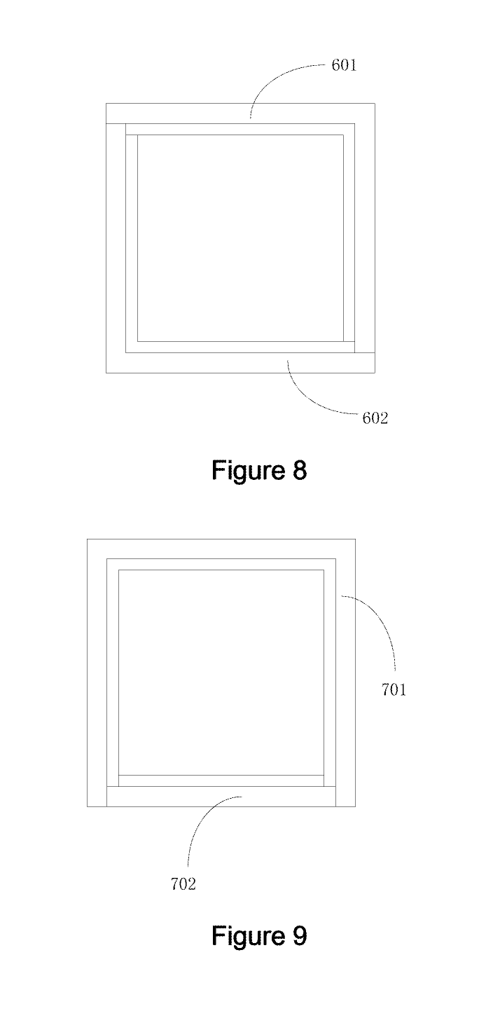

The following introduces the structure of the middle frame 10. In the first and second embodiment of the LCD module, the middle frame 10 includes a plastic portion and a rubber portion. The plastic portion and the rubber portion can be enclosed to form the middle frame 10. The portion of the middle frame 10 corresponding to the light source 13 is preferred to provide for the plastic portion. On the contrary, the portion of the middle frame 10 not corresponding to the light source 13 is preferred to provide for the rubber portion. Please refer to FIG. 4 to FIG. 9 for detail description of the various embodiments of the middle frame 10 of the present invention.

First, as shown in FIG. 4, FIG. 4 is a front view of the middle frame 10 of the first embodiment of the present invention. The middle frame 10 includes a plastic portion and the rubber portion. In one implementation, the plastic portion has one plastic section 201 and the rubber portion has three rubber sections 202, 203, 204. One plastic section 201 and three sections 202, 203, 204 are enclosed to form the middle frame 10. In addition, according to another implementation, the middle frame 10 includes a plastic portion having two plastic sections 201, 202 and a rubber portion having two rubber sections 203, 204. In this case, two plastic sections 201, 202 and two rubber sections 203, 204 are enclosed alternately to form the middle frame 10, wherein the plastic sections and the rubber sections are rectangles.

Please refer to FIG. 5, FIG. 5 is a front view of the middle frame 10 of the second embodiment of the present invention. As shown in FIG. 5, the middle frame 10 includes a plastic portion 301 and a rubber portion 302. The plastic portion 301 and the rubber portion 302 are L shape. In this case, one plastic portion 301 and one rubber portions 302 are enclosed to form the middle frame 10.

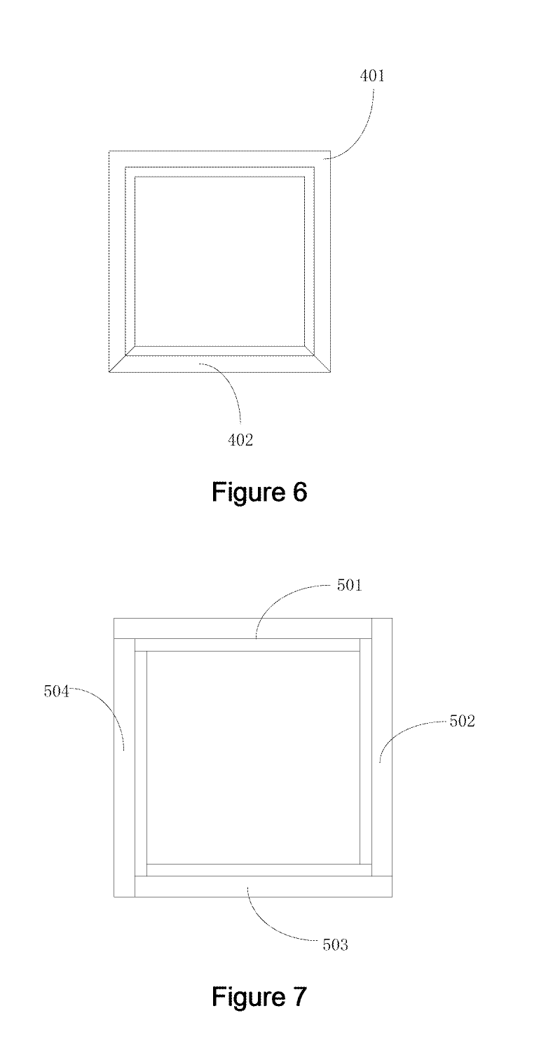

Please refer to FIG. 6, FIG. 6 is a front view of the middle frame 10 of the third embodiment of the present invention. As shown in FIG. 6, the middle frame 10 includes a plastic portion 401 and a rubber portion 402, wherein the rubber portion 402 is a rectangle and the plastic portion 401 is n shape. In this case, one plastic portion 401 and one rubber portion 402 are enclosed to form the middle frame 10. It should be understand that the plastic portion 401 could be a rectangle, and the rubber portion 402 could be n shape in other embodiments. In summary, the shapes of the plastic portion and the rubber portion of the middle frame 10 can be provided according to actual requirements. The present invention does not limit it specifically.

The following FIG. 7 to FIG. 9 show the front view of the fourth to the sixth embodiment of the middle frame 10. The differences between FIG. 4 to FIG. 6 and FIG. 7 to FIG. 9 are that the arrangement of the splicing surfaces of the plastic portion and the rubber portion are different. In FIG. 4 to FIG. 6, the splicing surfaces are planes. In FIG. 7 to FIG. 9, the splicing surfaces are ladder shapes with multiple planes. Of course, the present invention is not limited to any specific shape of the splicing surface of the plastic portion and the rubber portion. Any shape, which the person of ordinary skill according to the present invention can easily think of, can be applied in the present invention.

Besides, splicing methods of the plastic portion and the rubber portion can be various ways according to existing technologies, such as laser welding, riveting, screws, etc. The present invention does not limit to it.

Comparing to the conventional art using injection molding to form the middle frame 10 consisting of plastic, the middle frame 10 of the present invention comprises the plastic portion and the rubber portion. As a result, the present can reduce the manufacturing cost of the middle frame 10, and increase elasticity of the middle frame 10. In addition, different shapes of plastic and rubber portions can be interchangeably used in different liquid crystal display modules so that increases the versatility of the parts.

For example, as shown in FIG. 2, when assembling the middle frame 10, it may be preferred that the plastic portion of the middle frame 10 disposes near the light source 13, and non-light incident sides of the middle frame 10 of are all or part of the rubber portion (depending on the assembly structures of the middle frames 10 shown in FIG. 4 to FIG. 9). Excellent rubber elasticity has good cushioning effect, enabling the LCD panel 15 and the rubber portion of the middle frame 10 to be close after assembly. Besides, when the LCD panel 15 expands with heat, the rubber portion of the middle frame 10 can absorb the thermal expansion of the LCD panel 15.

At the same time, the rubber portion of the middle frame 10 is disposed between the light guide plate 14 and the back frame 12 so that the thermal expansion of the light guide plate 14 can use absorbed by the elasticity of the rubber portion. When the external environment back to normal, the elasticity of the rubber portion can help the LCD panel 15 and light guide plate 14 recovering to their original position.

The plastic portion of the middle frame 10 has certain hardness for supporting LCD panel 15; therefore, it can ensure the relative position of the LCD panel 15 and the front frame 11.

Therefore, the present invention utilizes the plastic portion and the rubber portion to be enclosed to form the middle frame 10, reducing manufacturing costs of the middle frame 10 and increasing the elasticity of the middle frame 10.

The above the embodiments of the present invention are not used to limit the scope of the appended claims of the present invention. Any equivalent structures in the specification or drawings or equivalent processes, or directly or indirectly used in other related technical fields are within the scope of the appended claims of the present invention.

What is claimed is:

1. A liquid crystal display module comprising:
a light guide plate having a light incidence surface;
a light source disposed at the light incidence surface of the light guide plate;
a middle frame having a plastic portion and a rubber portion, wherein the plastic portion and the rubber portion are enclosed to form the middle frame, and the portion of the middle frame corresponding to the light source is provided for the plastic portion, and the portion of the middle frame 10 not corresponding to the light source is provided for the rubber portion, and the plastic portion and the rubber portion are rectangles; and
a back frame having a sidewall, wherein the back frame is used for carrying the light guide plate, and the light source is disposed at the sidewall of the back frame.

2. The liquid crystal display module as claimed in claim 1, wherein the plastic portion has one plastic section and the rubber portion has three rubber sections, and the one plastic section and the three rubber sections are enclosed to form the middle frame.

3. The liquid crystal display module as claimed in claim 1, wherein the plastic portion has two plastic sections and the rubber portion has two rubber sections, and the two plastic sections and the two rubber sections are enclosed alternately to form the middle frame.

4. The liquid crystal display module as claimed in claim 1, wherein the liquid crystal display module further comprising:
a liquid crystal display panel carried on the middle frame; and
a front frame engaged with the back frame for fixing the liquid crystal display panel.

5. A liquid crystal display module comprising:
a light guide plate having a light incidence surface;
a light source disposed at the light incidence surface of the light guide plate; and
a middle frame having a plastic portion and a rubber portion, wherein the plastic portion and the rubber portion are enclosed to form the middle frame, and the portion of the middle frame corresponding to the light source is provided for the plastic portion, and the portion of the middle frame 10 not corresponding to the light source is provided for the rubber portion.

6. The liquid crystal display module as claimed in claim 5, wherein the plastic portion has one plastic section and the rubber portion has three rubber sections, and the one plastic section and the three rubber sections are enclosed to form the middle frame.

7. The liquid crystal display module as claimed in claim 5, wherein the plastic portion has two plastic sections and the rubber portion has two rubber sections, and the two plastic sections and the two rubber sections are enclosed alternately to form the middle frame.

8. The liquid crystal display module as claimed in claim 5, wherein the plastic portion and the rubber portion are rectangles.

9. The liquid crystal display module as claimed in claim 5, wherein the liquid crystal display module further comprises a back frame for carrying the light guide plate, and the light source fix to the sidewall of the back frame.

10. The liquid crystal display module as claimed in claim 9, wherein the liquid crystal display module further comprising:
a liquid crystal display panel carried on the middle frame; and
a front frame engaged with the back frame for fixing the liquid crystal display panel.

11. A middle frame comprising:
a plastic portion; and
a rubber portion;
wherein the plastic portion and the rubber portion are enclosed to form the middle frame.

12. The middle frame as claimed in claim 11, wherein the plastic portion has one plastic section and the rubber portion has three rubber sections, and the one plastic section and the three rubber sections are enclosed to form the middle frame.

13. The middle frame as claimed in claim 11, wherein the plastic portion has two plastic sections and the rubber portion has two rubber sections, and the two plastic sections and the two rubber sections are enclosed alternately to form the middle frame.

14. The middle frame as claimed in claim 11, wherein the plastic portion and the rubber portion are rectangles.
